(19) United States
(12) Patent Application Publication
(10) Pub. No.: US 2008/0162537 A1
(43) Pub. Date: Jul. 3, 2008

(54) Method and system for utilizing profiles

(75) Inventor: Massimiliano Mancini, San Jose, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc.

(21) Appl. No.: 11/647,725

(22) Filed: Dec. 29, 2006

(51) Int. Cl. G06F 17/30

(52) U.S. Cl. 707/102; 707/E17.044

(57) ABSTRACT

A method and system for utilizing profiles. Browsing data received from a site may be parsed using a behavior file. The behavior file may define how the browsing data is parsed for the site to identify at least one heading and/or topic within the browsing data. The parsed browsing data may be analyzed with an analysis file to identify one or more system generated user interests. The analysis file may define how the parsed browsing data is to be analyzed to generate the system generated user interests. A user profile may be updated with the system generated user interests. The browsing data may be stored as one or more identification data structures. Each identification data structure may include an identified terms field to retain one or more identified terms that are identified when parsing the browsing data and historical data regarding identification of the identified terms within the browsing data.

### TECHNICAL FIELD

The present application relates generally to the field of user profiles and, in one specific example, to a method and system for creating and using system generated user interests for a user profile.

### BACKGROUND

Sites collect information regarding user interactions to provide customized user experiences including promotional opportunities to users. For example, a cookie may be placed on a computer of a user to identify the user when interacting with the site and to track the user's interactions with the site. The collected information regarding the user is retained on the site (e.g., server-side) and is generally not provided from a first site to a second site unless the sites are affiliated. The user is not ordinarily provided with an opportunity to review the information collected by the site regarding the user's activity.

### BRIEF DESCRIPTION OF THE DRAWINGS

Some embodiments are illustrated by way of example and not limitation in the figures of the accompanying drawings in which:

FIG. 1 is a network diagram depicting a network system, according to one embodiment, having a client server architecture configured for exchanging data over a network;

FIG. 2 is a block diagram illustrating an example embodiment of multiple network and marketplace applications, which are provided as part of the network-based marketplace;

FIG. 3 is a block diagram of a network system for exchanging data over a network according to an example embodiment;

FIG. 4 is a block diagram of an example identification data structure;

FIG. 5 is a block diagram of an example heading data structure;

FIG. 6 is a block diagram of an example site data structure;

FIG. 7 is a block diagram of an example user profile data structure;

FIG. 8 is a block diagram of an example site profile data structure;

FIG. 9 is a block diagram of an example site profiles repository data structure;

FIG. 10 is a block diagram of an example user profiling application;

FIG. 11 is a flowchart illustrating a method for site communication according to an example embodiment;

FIG. 12 is a flowchart illustrating a method for downloading processing files according to an example embodiment;

FIG. 13 is a flowchart illustrating a method for configuring a user file according to an example embodiment;

FIG. 14 is a flowchart illustrating a method for browsing a site according to an example embodiment;

FIG. 15 is a flowchart illustrating a method for parsing browsing data with a behavior file according to an example embodiment;

FIG. 16 is a flowchart illustrating a method for analyzing the parsed browsing data with an analysis file according to an example embodiment;

FIG. 17 is a flowchart illustrating a method for analyzing the parsed browsing data with an analysis file according to an example embodiment;

FIG. 18 is a flowchart illustrating a method for accessing a site selection according to an example embodiment;

FIG. 19 is a flowchart illustrating a method for providing site access according to an example embodiment;

FIG. 20 is a block diagram of a user interface according to an example embodiment; and

FIG. 21 is a block diagram diagrammatic representation of machine in the example form of a computer system within which a set of instructions, for causing the machine to perform any one or more of the methodologies discussed herein, may be executed.

### DETAILED DESCRIPTION

Example methods and systems for utilizing profiles are described. In the following description, for purposes of explanation, numerous specific details are set forth in order to provide a thorough understanding of example embodiments. It will be evident, however, to one skilled in the art that the present invention may be practiced without these specific detail

In an example embodiment, browsing data received from a site may be parsed using a behavior file. The behavior file may define how the browsing data is parsed for the site to identify at least one heading and/or topic within the browsing data. The parsed browsing data may be analyzed with an analysis file to identify one or more system generated user interests. The analysis file may define how the parsed browsing data is to be analyzed to generate the system generated user interests. A user profile may be updated with the system generated user interests. The browsing data may be stored as one or more identification data structures. Each identification data structure may include an identified terms field to retain one or more identified terms that are identified when parsing the browsing data and historical data regarding identification of the identified terms within the browsing data.

Sharing system generated user interests from a user profile may enable a user to receive customized content based on the system generated user interests from a number of sites, even when the system generated user interests were generated through activity over a number of sites. The generation of the system generated user interests on a client machine may offload processing responsibility from a site or central server. The ability of the user to suppress system generated user interests may encourage the user to develop and selectively share desired system generated user interests with selected sites.

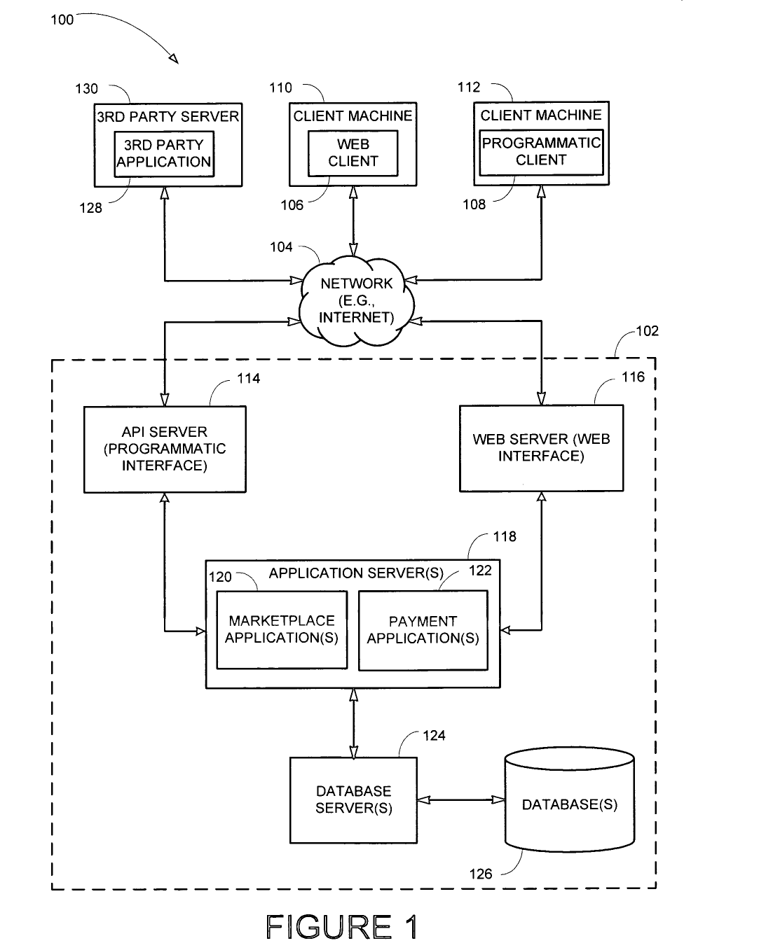

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Washington State), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

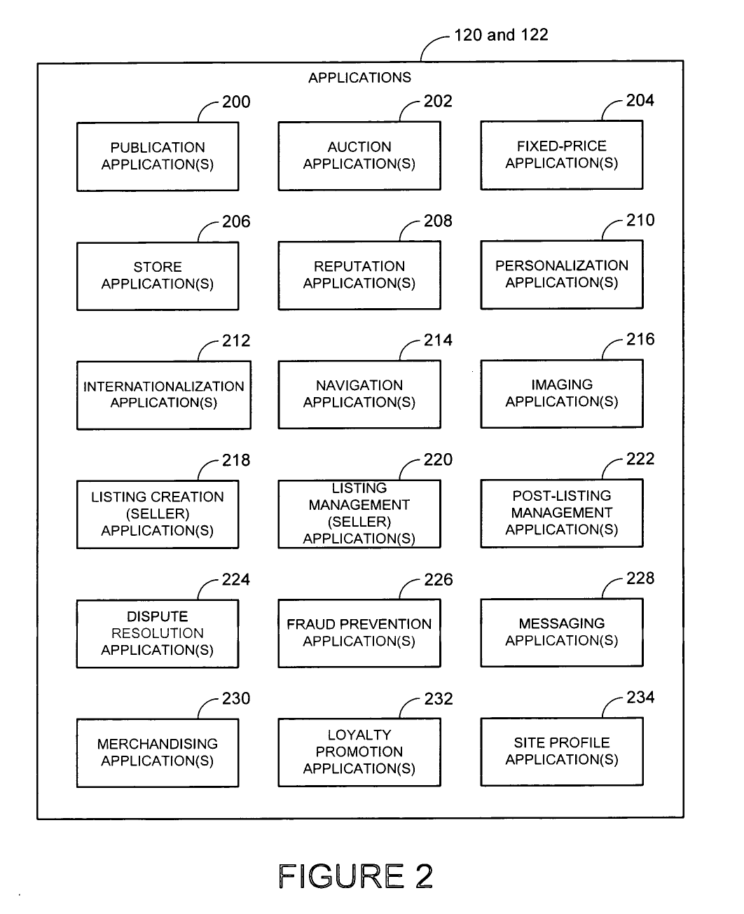

FIG. 2 is a block diagram illustrating multiple applications 120 and 122 that, in one example embodiment, are provided as part of the networked system 102 (see FIG. 1). The applications 120 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 126 via the database servers 124.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 are shown to include at least one publication application 200 and one or more auction applications 202 which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, utilizing the networked system 102, to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user, for example through feedback provided by other transaction partners, to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized and/or localized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable key word searches of listings published via the networked system 102. A browse application may allow users to browse various category, catalogue, or system inventory structures according to which listings may be classified within the networked system 102. Various other navigation applications may be provided to supplement the search and browsing applications.

In order to make listings, available via the networked system 102, as visually informing and attractive as possible, the marketplace applications 120 may include one or more imaging applications 216 utilizing which users may upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers conveniently to author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such messages for example advising users regarding the status of listings at the networked system 102 (e.g., providing “outbid” notices to bidders during an auction process or to provide promotional and merchandising information to users). Respective messaging applications 228 may utilize any one have a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotions points for each transaction established and/or concluded with a particular seller, and be offered a reward for which accumulated loyalty points can be redeemed.

Site profile applications 234 communicate with user profiling applications to obtain shared portions of user profiles from the users. The site profile applications 234 may then provide customized user experiences to the users that have provided a shared portion of their user profile. The shared portion of user profile obtained by the site profile applications 234 may be used in combination with other applications (e.g., the merchandising applications 230 and/or the loyalty promotion applications 232) to provide a customized user experience. An example embodiment of the site profile application 234 is described in greater detail below.

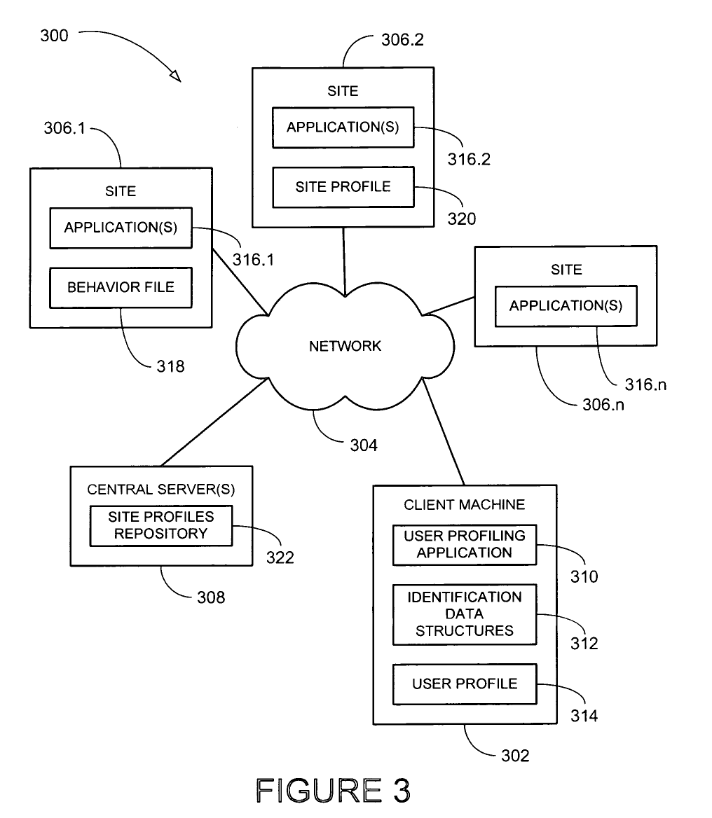

Referring to FIG. 3, a network system 300 for exchanging data over a network according to an example embodiment is illustrated. The network system 300 includes a client machine 302 communicating over a network 304 with a number (e.g., one or a plurality) of sites 306.1-306.n and an optional central server 308. In an example embodiment, the client machine 302 may include the functionality of the client machine 110 and/or the client machine 112 (see FIG. 1), and the sites 306.1-306.n may include the functionality of the third party server 130 and/or the application server 118. The client machine 302 may optionally include other functionality such as messaging applications (e.g., Instant Messenger by AOL LLC or Skype by Skype Limited).

The client machine 302 may include a user profiling application 310, identification data structures 312, and a user profile data structure 314. The user profiling application 310 may collect usage behavior by parsing browsing data into the form of the identification data structures 312.

The user profiling application 310 may then identify one or more system generated user interests from among the one or more identification data structures 312 that may be retained within the user profile data structure 314. For example, the user profiling application 310 may access through the web client 106 and/or the programmatic client 108 browsing data from provided by the applications 316.1-316.n of the sites 306.1-306.n, parse the received browsing data, and store the parsed browsing data in the form of the identification data structures 312. An example embodiment of the identification data structures 312 is described in greater detail below.

The user profiling application 310 may optionally be implemented as a plug-in to the web client 106 and/or the programmatic client 108 operating on the client machine 302 or may be an individualized application (e.g., on a desktop) on the client machine 302. For example, a user may input information into the web client 106 and/or the programmatic client 108 during searches (e.g., using Yahoo.com or Google.com) or visits to other websites and the browsing data from the searches or visits may be parsed by the user profiling application 310 and stored as the identification data structures 312. Clients that may also obtain browsing data that may be parsed by the user profiling application 310 include instant messaging (IM) clients, clients on Personal Digital Assistants (PDAs), clients on portable digital music players, clients on mobile phones, and the like.

The user profile data structure 314 may include interests of a user determined from parsed browsing data (e.g., system generated user interests) received from a first set of sites 306.1-306.n that may be used to provide interests to a second set of sites 306.1-306.n. An example embodiment of the user profile data structure 314 is described in greater detail below.

As shown, the sites 306-1.306.n may include a first site 306.1 with a first application 316.1 and a behavior file 318, a second site 306.2 with a second application 316.2 and a site profile data structure 320, and a third site 306.n with an application 316.n without the behavior file 318 or the site profile data structure 320. It should be appreciated that the networked system 300 may include a plurality of sites 306.1-306.n selected from among the first site 306.1, the second site 306.2, and the third site 306.n. For example, a particular site 306 may optionally include the behavior file 318 or the site profile data structure 320. An example embodiment of the behavior file 318 and the site profile data structure 320 is described in greater detail below.

One or more behavior files 318 and/or one or more analysis files may be sent to the client machine 302 over the network 304 in a distributed manner from the sites 306.1-306.n and/or a site profiles repository data structure 322 of the central server 308. The site profiles repository data structure 322 includes behavior files 318 and/or analysis files for a number of the sites 306.1-306.n. An example embodiment of the behavior file 318 and the site profiles repository data structure 322 is described in greater detail below. In an example embodiment, the central server 308 may include the application 316.

The user profiling application 310 may be dynamically updated with one or more behavior files 318 and/or one or more analysis files received from a corresponding site 306 and/or the central server 308. Upon receipt of the files, the user profiling application 310 may alter its creation and/or analysis of the identification data structures 312 based upon the receipt of the files.

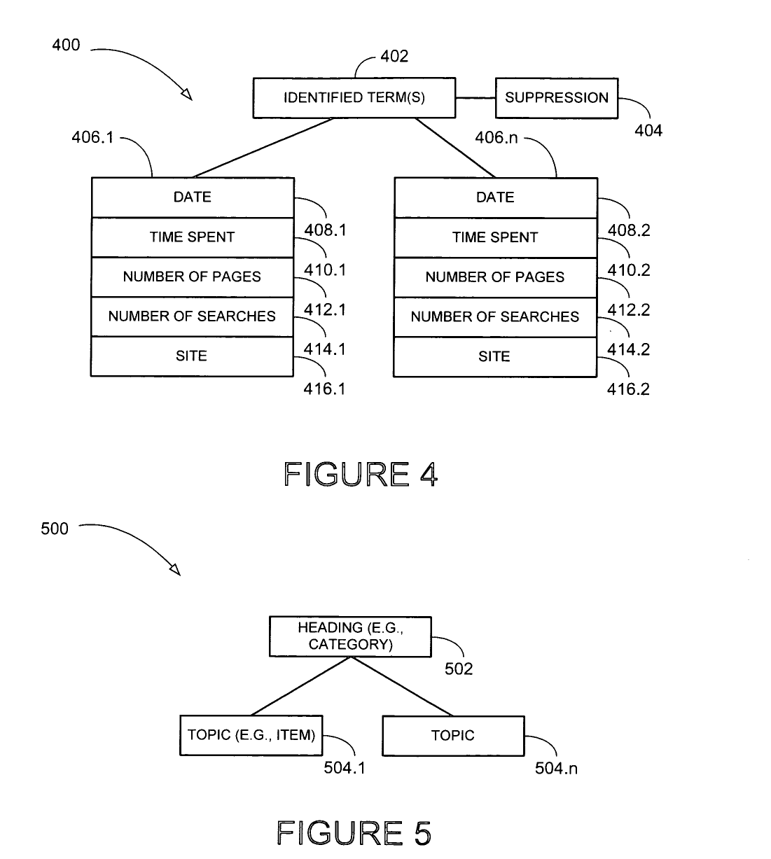

Referring to FIG. 4, an example identification data structure 400 is illustrated. In an example embodiment, the identification data structures 312 (see FIG. 3) may include a number (e.g., one or a plurality) of the identification data structures 400.

The identification data structure 400 includes an identified terms field 402, an optional suppression field 404, and a number of identification records 406.1-406.n.

The identified terms field 402 is a field to retain one or more identified terms when parsing the browsing data (e.g., as accessed by the web client 106 and/or the programmatic client 108). For example, the identified terms field 402 may retain a heading identified in the browsing data (e.g., for retaining a value such as San Jose news, digital cameras, or sports equipment), a topic identified in the browsing data (e.g., for retaining a value such as fashion, ten mega pixel digital cameras, or soccer balls), or an identified site 306 (e.g., ebay.com or yahoo.com) from which the browsing data was obtained.

The suppression field 404 retains indication of whether the identification data structure 400 is to be included when identifying system generated user interests from among the one or more identification data structures 312. For example, identification data structure 400 may include in system generated interest determinations for all of the sites 306, none of the sites 306, or for user specified sites 306. For example, the suppression field 404 may include a Boolean value (e.g., a value of true indicates suppressed and a value of false means not suppressed), a value array indicating sites (e.g., applications 316) that are to be suppressed, or the like.

The identification record 406 retains identification data for the identified terms. The identification data (e.g., historical data regarding identification of the identified terms within the browsing data) of the identification record 406 may include a date field 408, a time spent field 410, a number of pages field 412, a number of searches field 414, and/or a site field 416.

The date field 408 retains a date on which the identified terms were identified in the browsing data. For example, an identification record 406 may be created for each day on which the identified terms are identified in the browsing data.

The time spent field 410 retains an amount of time spent by a user viewing the received browsing data (e.g., by searching and receiving the browsing data) in which the identified terms were identified. For example, the time spent field 408 may indicate a time spent viewing the browsing data in which the identified terms were identified on a date indicated by the date field 408.

The number of pages field 412 retains a number of pages (e.g., web pages) of the browsing data accessed with the identified terms. For example, the number of pages field 412 may indicate a number of pages of the browsing data containing the identified terms on a date indicated by the date field 408.

The number of searches field 414 retains a number of times a search has been run in which the identified terms were identified in the browsing data. For example, the number of searches field 414 may indicate a number of searches in which the identified terms were identified in the browsing data on a date indicated by the date field 408.

The site field 416 retains a site 306 from which the identified terms were identified. For example, when the site field 414 is used with the identification record 406, each identification record 406 may retain values for a separate site 306. The date field 408 may then optionally be excluded from the identification record 406 to limit each site 306 to a single identification record, or may be included so that each site 306 may have an identification record 406 for every date in which identified terms were identified.

In an example embodiment, the identification data structure 400 is not provided to the sites 306.1-306.n (see FIG. 3). Rather, the sites 306.1-306.n may receive interests identified from analyzing the identification data structures 400 as described in greater detail below.

In an example embodiment, the user profiling application 310 (see FIG. 3) may receive and parse the browsing to create the identification data structures 312, 400 relating to e-commerce and/or non e-commerce interests. For example, the identification data structures 312, 400 may reflect non e-commerce activities such as local activities sites, social activities sites, and the like which may be shared with various sites 306 (e.g., a local ticketing company). By way of a further example, the user profiling application 310 may receive and parse browsing data relating to behavior on political websites and store the parsed data as the identification data structures 312, 400. The identification data structures 312, 400 may then be analyzed to identify system generated user interests with the user profile data structure 314.

In an example embodiment, the identification data structures 312, 400 may not be modified directly by the user but may only be updated by behavior. The user may optionally be able to purge some or all of the identification data structures 312, 400 stored on the client machine 302.

In an example embodiment, the identification records 406 that are beyond a certain date (e.g., too old) may be purged by the user profiling application 310.

Referring to FIG. 5, a block diagram of an example heading data structure 500 is illustrated. In an example embodiment, the heading data structure 500 may be used to organize and/or relate the identification data structures 312, 400 (see FIGS. 3 and 4). The identification data structures 312, 400 organized and/or related with the heading data structure 500 may include the optional site field 416 (see FIG. 4).

The heading data structure 500 may include a heading identification 502 and an optional number of topic identifications 504.1-504.n. In an example embodiment, the heading data structure 500 may be in the form of a tree with the heading identification 502 at a root and the topic identifications 504.1-504.n at nodes, however other data structures may also be used.

The heading identification 502 identifies a heading identified in parsed browsing data received from the user profiling application 310. For example, the headings may include a category (e.g., of items), a general topic of interest (e.g., politics or travel), and the like.

The optional topic identifications 504.1-504.n are topics identified in parsed browsing data that are associated with the heading identification 502. For example, the topic identifications 504.1-504.n may include items (e.g., toy cars or digital cameras) specific topics of interest (e.g., a political candidate or travel to San Jose, Calif.), and the like.

Each of the identifications 502, 504 may be associated (e.g. linked) with a identification data structure 400. For example, the headings and/or the topics of the identifications 502, 504 may be retained in the identified terms field 402 (see FIG. 4) of the identification data structure 400.

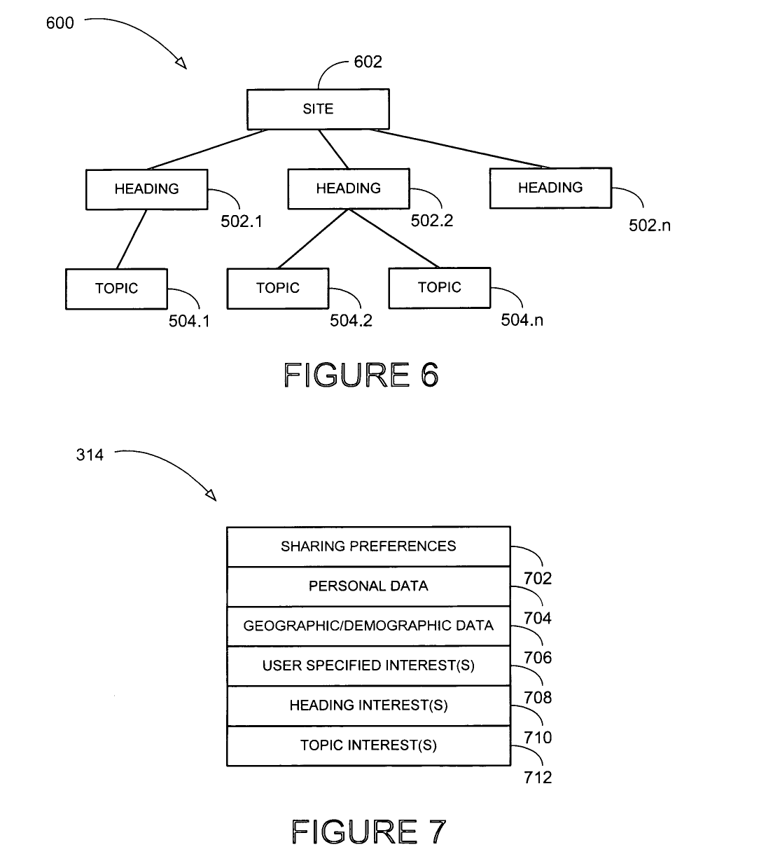

Referring to FIG. 6, a block diagram of an example site data structure 600 is illustrated. In an example embodiment, the site data structure 600 may be used to organize and/or relate the identification data structures 312, 400 (see FIGS. 3 and 4). The identification data structures 312, 400 organized and/or related with the site data structure 600 may exclude the optional site field 416 (see FIG. 4).

The site data structure 600 may include a site identification 602, a number of heading identifications 604.1-604.n and an optional number of topic identifications 606.1-606.n. In an example embodiment, the site data structure 600 may be in the form of a tree with the site identification 602 at a root, and the heading identifications 604.1-604.n and/or the topic identifications 606.1-606.n at nodes, however other data structures may also be used.

The site identification 602 identifies a site 306 (see FIG. 3) at which the user has received browsing data. A number of heading identification 502 (see FIG. 5) may be associated with the site identification 602, and a number of topic identifications 504.1-504.n may optionally be associated with each of the topic identifications 504.1-504.n.

Referring to FIG. 7, an example user profile data structure 314 (see FIG. 3) is illustrated. The user profile data structure 314 may include a sharing preferences field 702, a personal data field 704, a geographic/demographic data field 706, a user specified interests field 708, a heading interests field 710, and/or a topic interests field 712.

The sharing preferences field 702 may retain sharing indications to designate a portion of the user profile data structure 314 that may be shared with the sites 306 (see FIG. 3). For example, all of the sites 306.1-306.n may have same access to a shared portion of the user profile data structure 314, or applications 316 from among all of the application 316.1-316.n may be provided with specified access (or lack thereof) to a shared portion of the user profile data structure 314.

The shared portion of the user profile data structure 314 may be an entire field or a portion thereof. For example, some heading and topic interests of the heading interests field 710 and the topic interests field 712 may be shared with all sites 306, some heading and topic interests may be shared with no sites 306, and some heading and topic interests may be shared with selected sites 306. In an example embodiment, specifying portions of the heading interests field 710 and/or the topic interests field to not share may record a value indicating suppression in the suppression field 404 (see FIG. 4).

The personal data field 704 retains personal data of a user of the user profile data structure 314. For example, the personal data field 704 may include a first name, a last name, an address, a telephone number, an e-mail address, race, sex, and the like of the user.

The geographic/demographic data field 706 retains geographic and/or demographic information on the user. For example, the geographic information may include information on a geographic location of the user, while demographic information may include demographic information on the user. The geographic/demographic data contained with the data field 706 may optionally be derived from personal data contained within the personal data field 704 or completed with information obtained from the user through a user interface and/or other data source.

The user specified interests field 708 may retain interests specified by the user (e.g., interests not derived from browsing data). For example, the user specified interests field 708 may indicate interests received from a user by completing an online profile.

The heading interests field 710 retains one or more headings (e.g., categories of items) determined to be of interest to a user associated with the user profile data structure 314 based on the analysis performed by the user profiling application 310 on the identification data structures 312, 400 (e.g., a system generated user interest). For example, the heading interests field 710 may reflect that a user is interested in electronics or sports.

The topic interests field 712 retains one or more topics (e.g., items) determined to be of interest to a user associated with the user profile data structure 314 based on the analysis performed by the user profiling application 310 on the identification data structures 312, 400 (e.g., a system generated user interest). For example, the topic interests field 712 may reflect that a user is interested in a digital camera or a soccer ball.

When portions of the interest fields 708-712 are shared heterogeneous information may be provided to the applications 316.1-316.n regarding interests of the user. The interests may be used to enable the sites 306.1-306.n to provide the user with promotional opportunities (e.g., coupons and specials), customized browsing data, recommendations, and the like.

In an example embodiment, the headings and/or topics of interest may be based on and associated with one or more analysis files. The headings and/or topics of interest provided to a first application 316 (see FIG. 3) may then be different than the headings and/or topics of interest provided to a second application 316 based on a site analysis file used with the user profiling application 310.

In an example embodiment, the heading interests field 710 and the topic interests field 712 may not be modified by a user. The headings and/or topics may be suppressed to all or some of the sites 306 through use of the sharing preferences field 702.

The system generated user interests of the user profile data structure 314 may be generated by the user profiling application 310 based on interactions with a first set of sites 306.1-306.n and a shared portion of the user profile data structure 314 may be provided to a second set of sites 306.1-306.n. The first and the second set of sites 306.1-306.n may include the identical sites 306 or a number of different sites 306. In an example embodiment, the creation and use of the user profile data structure 314 client-side may enable use with a large number of the sites 306.1-306.n and thereby providing for ease of scaling.

A user may optionally have multiple user profile data structures 314 stored within the client machine 302 (see FIG. 3). For example, each of the user profile data structures 314 may be for a different kind of activity such as an ecommerce profile, a news profile, a sports profile, and the like. In an example embodiment, the user may have a single user profile data structure 314 for all activities.

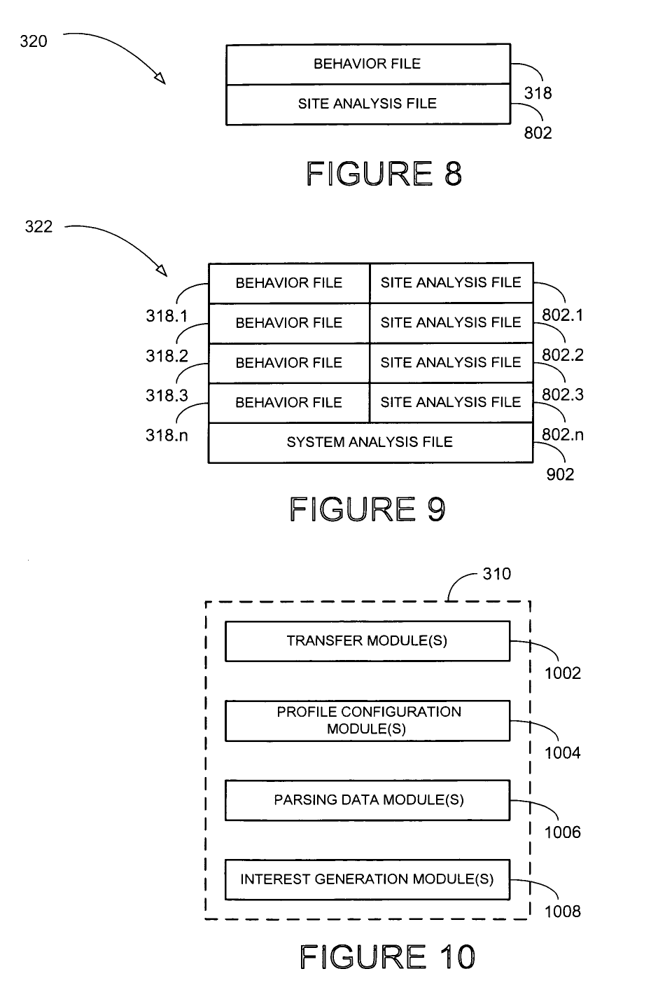

Referring to FIG. 8, an example site profile data structure 320 (see FIG. 3) is illustrated. The site profile data structure 800 may include a behavior file 318 and a site analysis file 802.

The behavior file 318 defines how browsing data may be parsed (e.g., by the user profiling application 310) for a particular site 306 to identify headings and/or topics within the browsing data.

By way of an example, the behavior file 318 may be a definition file that defines how to identify headings and/or topics within a web-based document (e.g., in HTML or XML format). The behavior file 318 may identify elements to search for within the web-based document to capture headings and topics. For example, when searching on a heading of “books”, an ISBN number may be used to identify a “topic” of specific books or book types

The behavior files 318 may be created by a party associated with a corresponding site 306 and/or may be created by a third party.

The site analysis file 802 defines how the parsed browsing data (e.g., the identification data structures 312, 400) are to be analyzed (e.g., by the user profiling application 310) for an associated site 306 to generate system created interests (e.g., a heading interest and/or a topic interest) for use with the associated site 306. For example, the site analysis file 802 may indicate that a certain number of searches that include a heading may result in a heading interest being reflected in the heading interests field 710 of the user profile data structure 314 (see FIGS. 3 and 7) for the site 306 associated with the site analysis file 802.

The site analysis file 802 may optionally specify that the identification data structures 312, 400 are to be analyzed from a single site 306, a group of selected sites 306, or all of the sites 306. For example, the site analysis file 802 may indicate a system generated user interest should be recorded in the user profile data structure 314 when a certain number of searches occurs on topic or category on a certain number of sites 306 within a certain time period.

Referring to FIG. 9, an example site profiles repository data structure 322 (see FIG. 3) according to an example embodiment is illustrated. The site profiles repository data structure 322 may include a number of behavior files 318.1-318.n, a number of site analysis files 802.1-802.n, and/or a system analysis file 902.

The behavior files 318.1-318.n and/or the site analysis files 802.1-802.n may be available for a number of sites 306. For example, the behavior files 318 and/or the site analysis files 802 may be received by the user profiling application 310 from the site profiles repository data structure 322 instead of the site 306 to which the behavior files 318 and/or the site analysis files 802 relate.

The system analysis file 902 defines how the parsed browsing data (e.g., the identification data structures 312, 400) are to be analyzed (e.g., by the user profiling application 310) to create system generated user interests (e.g., a heading interest and/or a topic interest) for use by the sites 306.1-306.n.

The system analysis file 902 may be used by the user profiling application 310 to create system generated user interests for sites 306 that do not have a site analysis file 802 or for all sites 306 (e.g., instead of using the site analysis files 802). For example, the use of the system analysis file 902 without the use of the site analysis files 802 may provide system generated user interests in a consistent manner across all of the sites 306.

In an example embodiment, the system analysis file 902 may be defined by a standards committee or a working group to define site analysis across multiple sites.

Referring to FIG. 10, an example user profiling application 310 (see FIG. 3) is illustrated. The profiling application 310 may include one or more transfer modules 1002, one or more profile configuration modules 1004, one or more parsing data modules 1006, and one or more interest generation modules 1008.

The transfer module 1002 receives files to and from the user profiling application 310 and provides a shared portion of the user profile data structure 314 (see FIG. 3). For example, the transfer module 1002 may enable receiving of the behavior file 318, the site analysis file 802, and/or the system analysis file 902 (see FIGS. 3, 8 and 9) from the site 306 and/or the central server 308 and providing of heading and/or topic interests from the heading interests field 710 and/or the topic interest field (see FIG. 7).

The profile configuration module 1004 configures the user profile data structure 314. For example, profile configuration module 1004 may be used to designate shared portions of the user profile data structure 314.

The parsing data module 1006 parses the browsing data to create the identification data structures 312, 400 (see FIGS. 3 and 4). The interest generation module 1008 identifies one or more system generated user interests from the parsed browsing data (e.g., identification data structures 312, 400) for the user profile data structure 314.

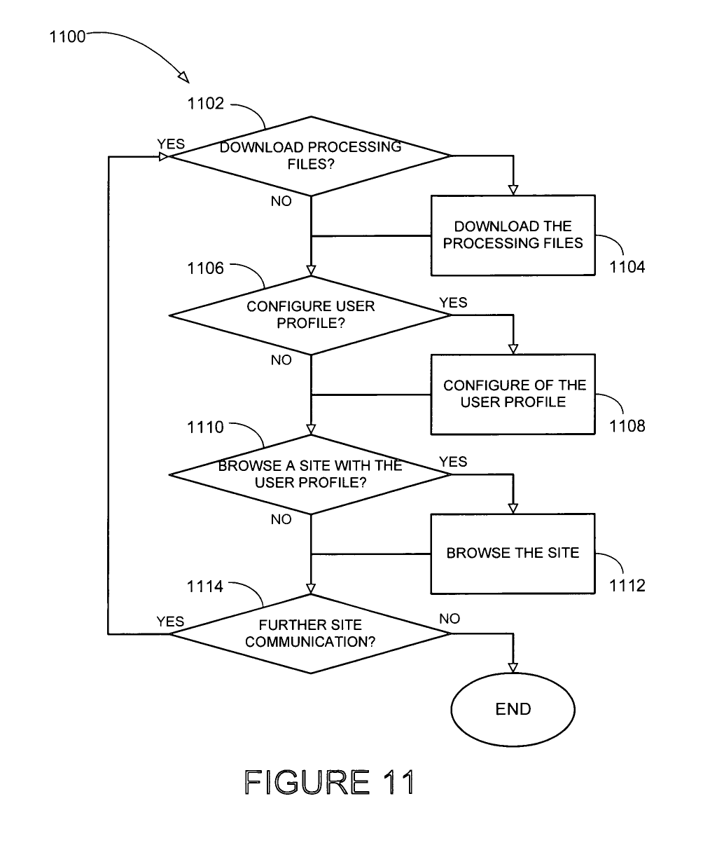

Referring to FIG. 11, a method 1100 for site communication according to an example embodiment is illustrated. In an example embodiment, the method 1100 may be performed by the user profiling application 310 (see FIG. 3).

At decision block 1102, a determination may be made whether to download processing files (e.g., a behavior file, a site analysis file, and/or a system analysis file) from the site 306 or the central server 308 (see FIG. 3). If a determination is made to download the processing files, the processing files may be downloaded at block 1104. An example embodiment of downloading the processing files is described in greater detail below. If a determination is made not to download the processing files or upon completion of the operations at block 1104, the method 1100 may proceed to decision block 1106.

At decision block 1106, a determination may be made whether to configure the user profile data structure 314 (see FIG. 3). If a determination is made to configure the user profile data structure 314, the user profile data structure 314 may be configured at block 1108. An example embodiment of configuring the user profile data structure 314 is described in greater detail below. If a determination is made not to configure the user profile at decision block 1106 or upon completion of the operations at block 1108, the method 1100 may proceed to decision block 1110.

A determination may be made at decision block 1110 whether to browse the site 306 with the user profile data structure 314. If a determination is made to browse the site 306 with the user profile data structure 314, the site may be browsed at block 1112. An example embodiment of browsing the site 306 with the user profile data structure 314 is described in greater detail below. If a determination is made not to browse the site 306 with the user profile data structure 314 at decision block 1110 or upon completion of the operations at block 1112, the method 1100 may proceed to decision block 1114.

At decision block 1114, a determination may be made whether there is further site communication. If a determination is made that there is site communication, the method 1100 may return to decision block 1102. If a determination is made that there are no further site communication, the method 1100 may terminate.

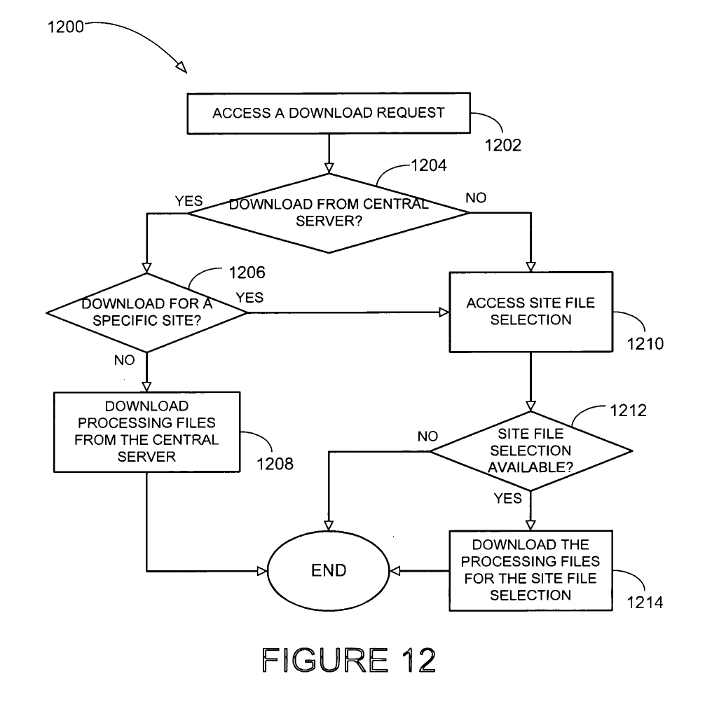

Referring to FIG. 12, a method 1200 for downloading processing files according to an example embodiment is illustrated. In an example embodiment, the method 1200 may be performed at block 1104 (see FIG. 11).

A download request for processing files may be accessed at block 1202. For example, the user profiling application 310 (see FIG. 3) may receive the download request from a user, automatically be generated at predetermined times, and the like.

A determination may be made at decision block 1204 whether to download the processing files from the central server 308 (see FIG. 3). If the processing files are to be downloaded from the central server 308, the processing files may be downloaded from the central server 308 at block 1208. For example, all or a portion of the processing files available within the site profiles repository data structure 322 may be downloaded at block 1208.

If a determination is made at decision block 1204 not to download processing files from the central server 308 or if a determination is made at decision block 1206 to download the processing files for a specific site, a site file selection (e.g., a selection of processing files associated with the specific site 306) may be accessed at block 1210. For example, the site file selection may be selected by a user or received from a web client 106 and/or programmatic client 108.

A determination may be made at decision block 1212 whether the site file selection is available (e.g., whether the central server 308 and/or the specific site 306 have the processing files of the site file selection). If the site file selection is available, the processing files of the site file selection may be downloaded at block 1214. If the site file selection is not available at decision block 1212, or upon completion of the operations at block 1208 or block 1214, the method 1200 may terminate.

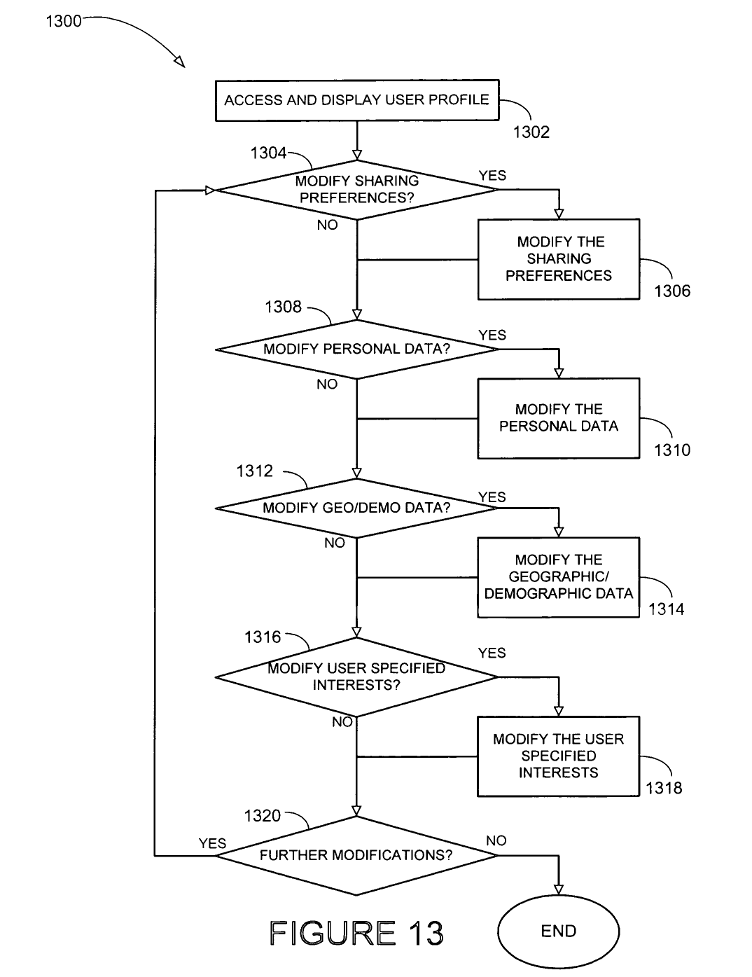

Referring to FIG. 13, a method 1300 for configuring the user profile data structure 314 (see FIG. 3) according to an example embodiment is illustrated. In an example embodiment, the method 1300 may be performed at block 1108 (see FIG. 11).

The user profile data structure 314 may be accessed and displayed (e.g., to the user through a user interface on the client machine 302) at block 1302.

A determination may be made at decision block 1304 whether to modify sharing preferences of the user profile data structure 314. For example, a portion of the profile data structure 314 may be designated for sharing with all sites 306, with none of the sites 306, or with a user selected sites 306. An example embodiment of a user interface for receiving the sharing preferences of the user is described in greater detail below.

If a determination is made to modify the sharing preferences, the sharing preferences field 702 (see FIG. 7) may be modified at block 1306. If the sharing preferences are not to be modified at decision block 1304 or upon completion of the operations at block 1306, the method 1300 may proceed to decision block 1308.

At decision block 1308, a determination may be made whether to modify the personal data. If a determination is made to modify the personal data, the personal data field 704 (see FIG. 7) may be modified at block 1310. If a determination is made not to modify the personal data at decision block 1308 or upon completion of the operations at block 1310, the method 1300 may proceed to decision block 1312.

A determination may be made at decision block 1312 whether to modify the geographic and/or demographic data. If a determination is made to modify the geographic and/or demographic data, the geographic/demographic data field 706 (see FIG. 7) may be modified at block 1314. If a determination is made at decision block 1312 not to modify the geographic and/or demographic data or upon completion of the operations at block 1314, the method 1300 may proceed to decision block 1316.

At decision block 1316, a determination may be made whether to modify the user specified interests. If a determination is made to modify the user specified interests, the user specified interests field 708 (see FIG. 7) may be modified at block 1318. If a determination is made not to modify the user specified interests at decision block 1316 or upon completion of the operations at block 1318, the method 1300 may proceed to decision block 1320.

A determination may be made at decision block 1320 whether to process further modifications. If a determination is made to process further modifications, the method 1300 may return to decision block 1304. If a determination is made not to process further modifications at decision block 1320, the method 1300 may terminate.

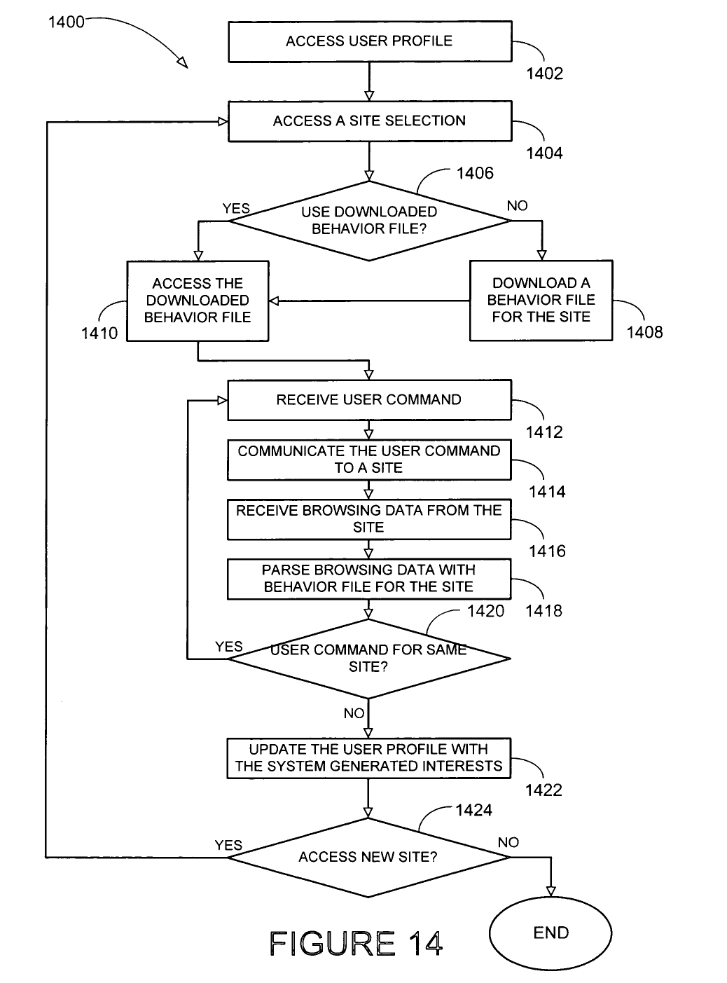

Referring to FIG. 14, a method 1400 for browsing a site according to an example embodiment as illustrated. In an example embodiment, the method 1400 may be performed at block 1112 (see FIG. 11).

The user profile data structure 314 (see FIG. 3) may be accessed (e.g., by the user profiling application 310) at block 1402. A site selection (e.g., a selection of a first site 306) may be accessed at block 1404. For example, accessing the site selection may be the user profiling application 310 accessing a uniform resource locator (URL) from the web client 106 (see FIG. 1), the programmatic client 108, or directly from the user.

A determination may be made at decision block 1406 whether to use a downloaded behavior file 318. If a determination is made not to use the downloaded behavior file 318, a behavior file 318 may be downloaded for the site 306 at block 1408. If a determination is made at decision block 1406 to use the downloaded site profile, or upon completion of the operations at block 1408, the downloaded behavior file 318 maybe accessed at block 1410.

A user command for the site 306 may be received at block 1412 and the user command may be communicated to the site 306 at block 1414.

Browsing data may be received in response from the site 306 at block 1416. The browsing data may be parsed using the behavior file 318 for the site 306 at block 1418 to create parsed browsing data. The parsed browsing data may optionally be in the form of the identification data structures 312, 400 (see FIGS. 3 and 4). An example embodiment of parsing the browsing data using the behavior file 318 is described in greater detail below.

A determination may be made at decision block 1420 whether a user command has been received for the same site 306 (e.g., the first site 306). If a user command has been received for the same site 306, the method 1400 may return to block 1412. If the user command is not received for the same site 306 at decision block 1420, the method 1400 may proceed to block 1422.

The user profile data structure 314 may be updated with the system generated user interests (e.g., heading interests and/or topic interests) at block 1422. In an example embodiment, the operations at block 1422 may precede the operations at block 1420.

A determination may be made at decision block 1424 whether to access a new site 306. If the determination is made to access the new site 306, the method 1400 may return to block 1404. If the determination is made not to access a new site 306 at decision block 1424, the method 1400 may terminate.

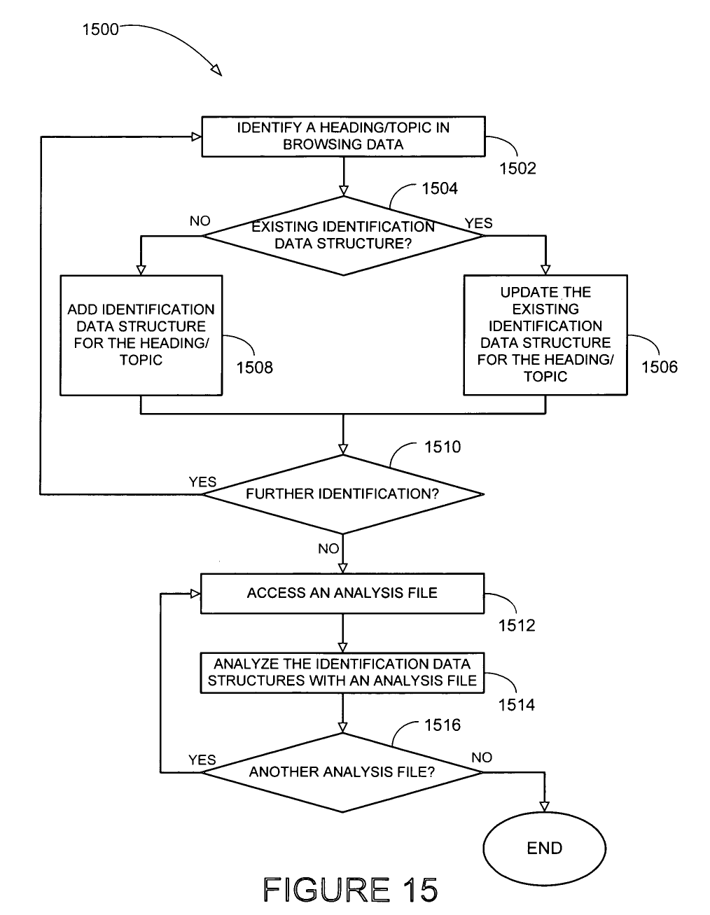

Referring to FIG. 15, a method 1500 for parsing browsing data with the behavior file 318 (see FIG. 3) according to an example embodiment as illustrated. In an example embodiment, the method 1500 may be performed at block 1418 (see FIG. 14).

A heading or topic may be identified in the browsing data using the behavior file 318 at block 1502. For example, the user profiling application 310 may use the behavior file 318 to assess key elements on a page of browsing data such as product category, brand name, product name, skew number, ISBN number, and the like. The key elements and associated browsing data may be accessed to identify one or more heading and/or one or more topics among the browsing data.

A determination may be made at decision block 1504 whether there is an existing identification data structure 400 (see FIG. 4) for the identified heading or topic. If there is an existing identification data structure 400, the existing identification data structure 400 may be updated for the heading or topic at block 1506. For example, a new identification record 406 may be created for the heading or topic, or one or more fields 408-414 of an existing identification record 406 may be updated at block 1506.

If a determination is made at decision block 1504 that there is not an existing identification data structure 400, a new identification data structure 400 may be added to the identification data structures 312 for the heading or topic at block 1508. For example, the identification data structure 400 may include the identified heading or topic in the identified terms field 402 (see FIG. 4).

Upon the completion of the operations at block 1506 or 1508, a determination may be made at decision block 1510 whether there is a further identification to be made in the browsing data. If there is a further identification in the browsing data, the method 1500 may return to block 1502. If a determination is made that there is not a further identification in the browsing data at decision block 1510, the method 1500 may proceed to block 1512.

An analysis file may be accessed at block 1512. For example, the analysis file may be the site analysis file 802 and the system analysis file 902 (see FIGS. 8 and 9).

The identification data structures 312, 400 may be analyzed with the analysis file at block 1514. An example embodiment of analyzing the parsed browsing data (e.g., the identification data structures 312, 400) with an analysis file is described in greater detail below.

A determination may be made at decision block 1516 as to whether there is another analysis file. If there is another analysis file, the method 1500 may return to block 1512. If there is not another analysis file at decision block 1516, the method 1500 may terminate.

In an example embodiment, the operations at block 1512-1516 may precede the operations at decision block 1510.

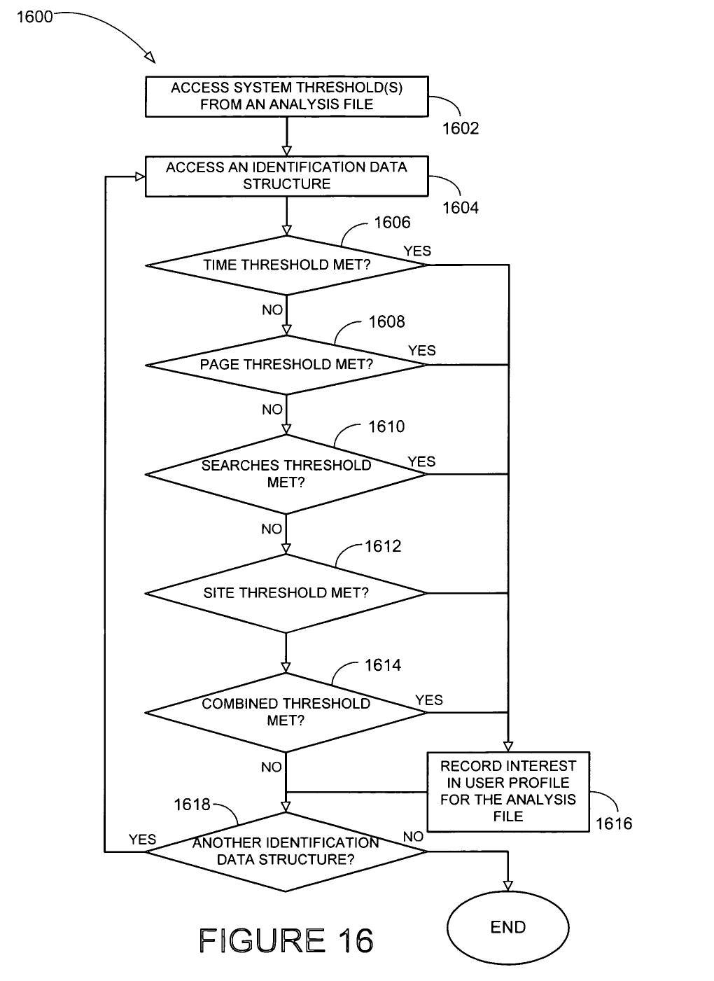

Referring to FIG. 16, a method 1600 for analyzing the parsed browsing data with an analysis file according to an example embodiment is illustrated. In an example embodiment, the method 1600 may be performed at block 1514 (see FIG. 15).

One or more system thresholds may be accessed from an analysis file (e.g., the site analysis file 802 or the system analysis file 902) at block 1602. For example, the system thresholds may be thresholds for determining whether a value is of a sufficient level to express a system generated user interest on behalf of the user in the user profile data structure 314 (see FIG. 3). The thresholds used for evaluating the identification data structures 312, 400 may be generated from a single site 306, across a number of selected sites 306, and/or across all sites 306.1-306. An identification data structure 400 (see FIG. 4) may be accessed at block 1604.

A determination may be made at decision block 1606 as to whether a time threshold has been met. For example, the time threshold may be a threshold amount of time (e.g., two hours) that the user has seeking browsing data for a heading or topic. If the time threshold has been met, the method 1600 may record a system generated user interest in the user profile data structure 314 at block 1616 for the analysis file accessed at block 1602. If a determination is made that the time threshold has not been met at decision block 1606, the method 1600 may proceed to decision block 1608.

At decision block 1608, a determination may be made as to whether a page threshold has been met. For example, the page threshold may a threshold number of pages (e.g., web pages) of browsing data that the user has received while seeking browsing data for a heading or topic. If a page threshold has been met, a system generated user interest may be recorded in the user profile data structure 314 at block 1616 for the analysis file accessed at block 1602. If the page threshold has not been met at decision block 1608, the method 1600 may proceed to decision block 1610.

A determination may be made at decision block 1610 whether a searches threshold has been met. For example, the search threshold may be a threshold number of searches run by the user on a heading or topic.

If the searches threshold has been met, a system generated user interest may be recorded in the user profile data structure 314 at block 1616 for the analysis file accessed at block 1602. By way of an example, if a user looks at a number of web pages (e.g., fifty web pages) for a period of time (e.g., a five day period of time) on a same heading or a same topic, then a system generated user interest for the heading or topic may be created within the user profile data structure 314 at block 1616. If the searches threshold has not been met at decision block 1610, the method 1600 may proceed to decision block 1612.

A determination may be made at decision block 1612 whether a site threshold is met. For example, the site threshold may a threshold number of the sites 306 at which the user has sought browsing data on a heading or topic, and/or a threshold number of times that the user has visited one or more of the sites 306 during a time period. By way of example, if the user receives browsing data from a site 306 specializing in digital cameras more than five times in a week, or if the user visits five digital camera stores in a day, the site threshold may be met. If the site threshold has been met, a system generated user interest may be recorded in the user profile data structure 314 at block 1616 for the analysis file accessed at block 1602. If the site threshold has not been met at decision block 1612, the method 1600 may proceed to decision block 1614.

At decision block 1614, a determination may be made as to whether a combined threshold has been met. For example, the combined threshold may be a combination of a number of other thresholds (e.g., a time threshold, a page threshold, a searches threshold, or a site threshold). If a combined threshold has been met, a system generated user interest may be recorded in the user profile data structure 314 at block 1616 for the analysis file accessed at block 1602. If the site threshold has not been met at decision block 1614 or upon completion of the operations at block 1616, the method 1600 may proceed to decision block 1618.

A determination may be made at decision block 1618 whether there is another identification data structure 400 to be accessed for a threshold analysis with the analysis file. If a determination is made that another identification data structure 400 is to be accessed, the method 1600 may return to block 1604. If a determination is made at decision block 1618 that there is not another identification data structure 400 for the analysis, the method 1600 may terminate.

In an example embodiment, the heading interests field 710 and the topic interests field 712 (see FIG. 7) may retain information regarding current system generated user interests and discard information that is no longer current during the operations at block 1616. For example, the heading interests field 710 and the topic interests field 712 may include information regarding repetitive behavior of the user passively collected (e.g., without the user specification) for certain headings and topics respectively.

In an example embodiment, the thresholds (e.g., the time threshold, the page threshold, the searches threshold, or the weighted threshold) may be evaluated for a single identification record 406 or multiple identification records 406 of a single user identification data structure 400, or for a single identification record 406 or multiple identification records 406 across multiple user identification data structures 400 for the same category or topic across multiple sites 306. It should be appreciated that the operations at blocks 1606-1614 may occur in any order.

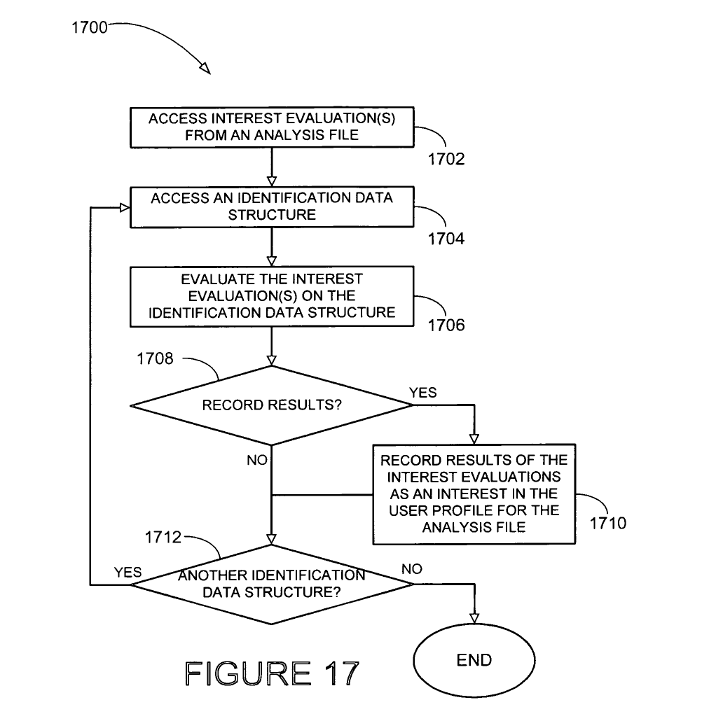

Referring to FIG. 17, a method 1700 for analyzing the parsed browsing data with an analysis file according to an example embodiment is illustrated. In an example embodiment, the method 1700 may be performed at block 1514 (see FIG. 15).

One or more interest evaluations may be accessed from an analysis file at block 1702. The interest evaluations are evaluations performed by the method 1700 one or more identification data structures 400 to determine whether a system generated user interest should appear in the user profile data structure 314 (see FIG. 3) and optionally an interest level at which the system generated user interest should appear. By way of an example, an interest evaluation may be that depending on a number of searches performed or pages received with browsing data for a topic or heading, a system generated user interest for a casual interest level interest, an enthusiast interest level, or a high interest level may be recorded in the user profile data structure 314. It should be appreciated that different types and/or numbers of levels may be used.

An identification data structure 400 (see FIG. 4) may be accessed at block 1704. The interest evaluation may be performed on the identification data structure 400 at block 1706. By way of example, the interest evaluation may be that if a user searches on a heading or topic for a half hour, the system generated user interest recorded in the user profile data structure 314 may be for a first level of interest and if the user searches on a heading or topic for five hours, the system generated user interest recorded in the user profile data structure 314 may be for a second level of interest.

It should be appreciated that the interest evaluation may optionally use results for a previous interest evaluation and/or identification data structure 400 in performed the interest evaluation at block 1706.

A determination may be made at decision block 1708 whether to record the results of one or more of the interest evaluations. If a determination is made to record the results, the results of the interest calculations may be recorded as an interest in the user profile data structure 314 for the analysis file at block 1710. If a determination is made not to record the results at decision block 1708 or upon completion of the operations at block 1710, the method 1700 may proceed to decision block 1712.

A determination may be made at decision block 1712 to access another identification data structure 400. For example, all identification data structures 312, 400 may be accessed by the method 1700, or a subset of the identification data structures 312, 400 may be accessed by the method 1700.

If another identification data structure 400 is to be accessed, the method 1700 may return to block 1702. If there is not another identification data structure at decision block 1712, the method 1700 may terminate.

In an example embodiment, the interest evaluations performed at block 1706 may also utilize the user specified interests of the user specified interests field 708.

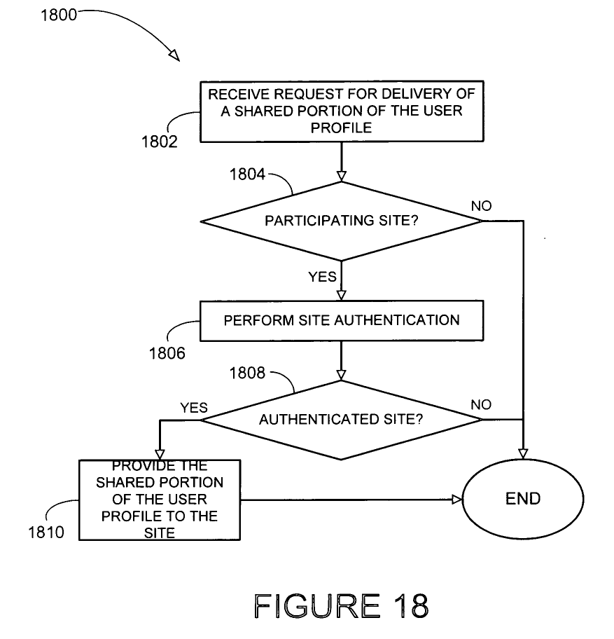

Referring to FIG. 18, a method 1800 for accessing a site selection according to an example embodiment is illustrated. In an example embodiment, the method 1800 may be performed at block 1404 (see FIG. 14).

A request may be received for a delivery of a shared portion of the user profile data structure 314 from a site 306 at block 1802.

A determination may be made at decision block 1804 as to whether the site 306 is a participating site 306. For example, the site 306 may be a participating site 306 if the site 306 has been authorized (e.g., by the creator and/or a distributor of the user profiling application 310). If the site 306 is an authorized site, a site authentication may be performed at block 1806. For example, the site authentication may be one or more security measures to ensure that the site 306 is authentic.

A determination may be made at decision block 1808 as to whether the site 306 has been authenticated by the operations at block 1806. If the site is authenticated, the shared portion of the user profile data structure 314 may be provided to the authenticated site 306 at block 1810. If the site is not authorized and/or authenticated, or upon completion of the operations at block 1810, the method 1800 may terminate.

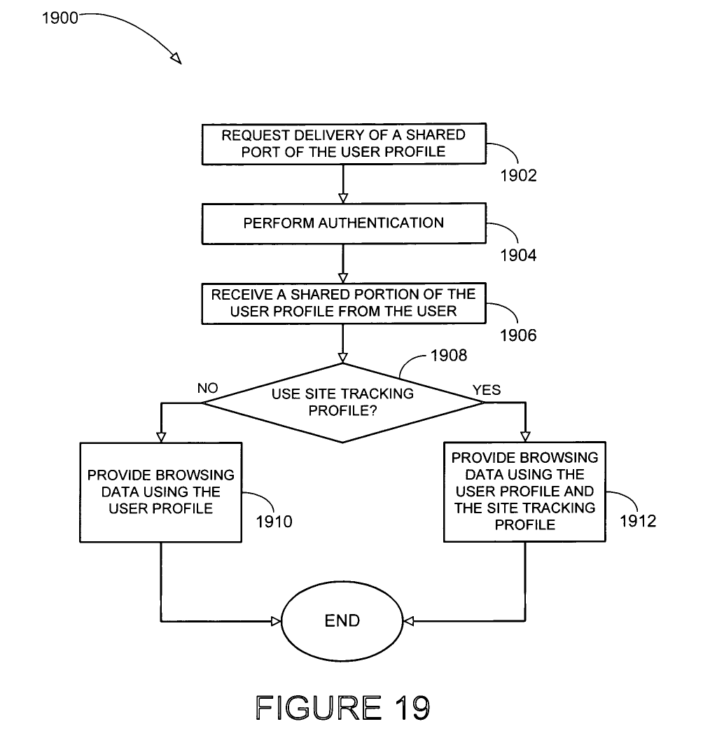

Referring to FIG. 19, a method 1900 for providing site access according to an example embodiment is illustrated. In an example embodiment, the method 1900 may be performed at block 1404 (see FIG. 14) and/or by the site profile application 234 (see FIG. 2).

A request for delivery of a shared portion of the user profile data structure 314 (see FIG. 3) may be provided at block 1902. For example, a site profile application 234 operating on the site 306 may request the shared portion of the user profile data structure 314 from the user profiling application 310.

An authentication may be performed at block 1904. For example, the operations at block 1904 and block 1904 (see FIG. 19) may authenticate the user profile application 310 and the site 306 using public key/private key encryption.

A shared portion of the user profile data structure 314 may be received from the user at block 1906. For example, the shared portion of the user profile data structure 314 may include one or more system generated interests from the heading interests fields 710 and/or the topic interests field 712. In an example embodiment, the system generated user interests may be generated client-side in response to analysis and parsing of browsing data received from a plurality of sites 306. The shared portion may optionally be received at block 1906 through a secure (e.g., encrypted) channel.

A determination may be made at decision block 1908 as to whether to use a site tracking profile in combination with the shared portion of the user profile data structure 314. For example, the site tracking profile may be a profile of the user created by the site 306 (e.g., generated server-side) based on the activity of the user with the site 306 and optionally its affiliated sites.

If the determination is made not to use the site tracking profile, browsing data using the shared portion of the user profile data structure 314 may be provided at block 1910. In an example embodiment, portions of the browsing data provided to the user may be customized for the user (e.g., customized browsing data) based on the use of the shared portion of the user profile data structure 314. The user may optionally receive promotional opportunities (e.g., coupons, discounts, etc.) within the browsing data.

If a determination is made to use the site tracking profile at decision block 1908, browsing data using the user profile data structure 314 and the site tracking profile may be used at block 1912. In an example embodiment, portions of the browsing data provided to the user may be customized for the user based on the use (e.g., customized browsing data) of the shared portion of the user profile data structure 314 and the site tracking profile. Upon completion of the operations at block 1910 or 1912, the method 1900 may terminate.

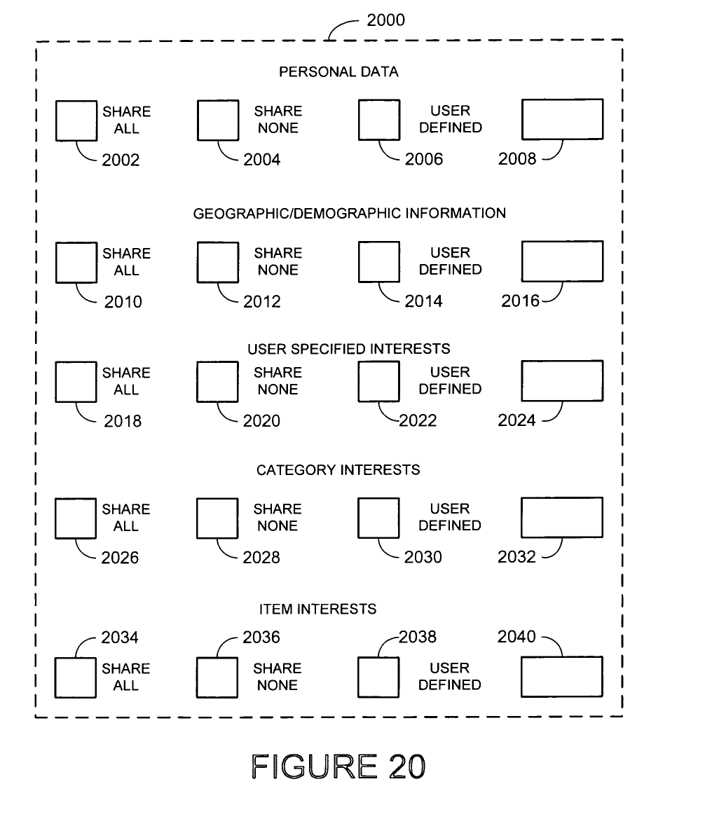

Referring to FIG. 20, a user interface 2000 according to an example embodiment is illustrated. In an example embodiment, the user interface 2000 may be presented to a user of the client machine 302 (see FIG. 3).

The user interface 2000 may include selections 2002 through 2008 for personal data, selections 2010 through 2016 for geographic and/or demographic information, selections 2018 through 2026 for user specified interest, selections 2028 through 2034 for category interest, and selections 2036 through 2042 for item interest.

The user may specify to share all personal data, share no personal data, or share a user defined amount of personal data by selecting a first selection 2002, a second selection 2004, or a third selection 2006 respectively. A user may specify the selection of user defined personal data with a fourth selection 2008.

All geographic/demographic information may be shared, no geographic/demographic information may be shared, or a user defined amount of geographic/demographic information may be shared by selecting a first selection 2010, a second selection 2012, or a third selection 2014 respectively. A user may specify the selection of user defined geographic/demographic information with a fourth selection 2016.

The user may specify to share all user specified interests, share no user specified interests, or share a user defined amount of user specified interests by selecting a first selection 2018, a second selection 2020, or a third selection 2022 respectively. A user may specify the selection of the user specified interests with a fourth selection 2024.

All category interests may be shared, no category interests may be shared, or a user defined amount of category interests may be shared by selecting a first selection 2026, a second selection 2028, or a third selection 2030 respectively. A user may specify the selection of user defined category interests with a fourth selection 2032.

The user may specify to share all item interests, share no item interests, or share a user defined amount of item interests by selecting a first selection 2034, a second selection 2036, or a third selection 2038 respectively. A user may specify the selection of the item interests with a fourth selection 2040.

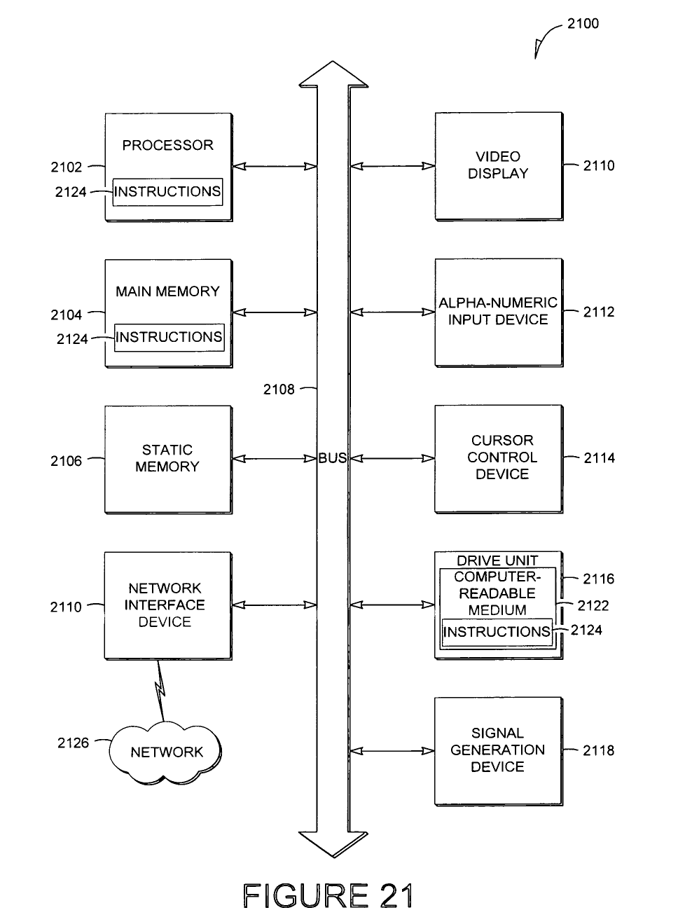

FIG. 21 shows a diagrammatic representation of a machine in the example form of a computer system 2100 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a portable digital music player (e.g., a MP3 player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2100 includes a processor 2102 (e.g., a central processing unit (CPU) a graphics processing unit (GPU) or both), a main memory 2104 and a static memory 2106, which communicate with each other via a bus 2108. The computer system 2100 may further include a video display unit 2110 (e.g., a liquid crystal display (LCD) or a cathode ray tube (CRT)). The computer system 2100 also includes an alphanumeric input device 2112 (e.g., a keyboard), a cursor control device 2114 (e.g., a mouse), a drive unit 2116, a signal generation device 2118 (e.g., a speaker) and a network interface device 2110.

The drive unit 2116 includes a machine-readable medium 2122 on which is stored one or more sets of instructions (e.g., software 2124) embodying any one or more of the methodologies or functions described herein. The software 2124 may also reside, completely or at least partially, within the main memory 2104 and/or within the processor 2102 during execution thereof by the computer system 2100, the main memory 2104 and the processor 2102 also constituting machine-readable media.

The software 2124 may further be transmitted or received over a network 2126 via the network interface device 2110.

While the machine-readable medium 2122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system for utilizing profiles have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A system comprising:
one or more identification data structures, each identification data structure comprising:
an identified terms field to retain one or more identified terms when parsing browsing data, the browsing data received by at least one of a web client or a programmatic client, and
historical data regarding identification of the one or more identified terms within the browsing data;
a user profiling application to access the one or more identification data structures and identify a system generated user interest from among the one or more identification data structures; and
a user profile data structure to retain the system generated user interest identified by the user profiling application.

2. The system of claim 1, wherein the one or more identified terms of a first identification data structure of the one or more identification data structures is a heading identified within the browsing data.

3. The system of claim 2, wherein the one or more identified terms of a second identification data structure of the one or more identification data structures is a topic of the heading identified within the browsing data.

4. The system of claim 1, wherein the one or more identified terms of a first identification data structure of the one or more identification data structures is a site from which the browsing data was obtained; and
wherein the one or more identified terms of a second identification data structure of the one or more identification data structures is a heading identified within the browsing data.

5. The system of claim 1, wherein the historical data regarding identification of the identified terms within the browsing data comprises one or more identification records, each of the one or more identification records comprise at least one of:
a date field to retain a date on which the one or more identified terms were identified in the browsing data;
a time spent field to retain an amount of time spent by a user viewing the browsing data in which the one or more identified terms were identified;
a number of pages field to retain retains a number of pages of the browsing data accessed with the one or more identified terms,
a number of searches field to retain a number of times a search has been run in which the one or more identified terms were identified in the browsing data, or
a site field to retain a site from which the one or more identified terms were identified.

6. The system of claim 1, wherein each of the one or more identification data structures further comprise:
a suppression field to retain indication of whether a particular identification data structure associated with the suppression field is to be included when identifying the system generated user interest from among the one or more identification data structures.

7. The system of claim 1, wherein the user profile data structure further comprises:
a heading interests field to retain a heading of a first system generated user interest; and
a topic interest field to retain a topic of a second system generated user interest.

8. The system of claim 7, wherein the user profile data structure further comprises at least one of:
a personal data field to retain personal data of a user of the user profile, a geographic/demographic data field to retain at least one of geographic or demographic information on the user, or
a user specified interests field to retain an interest specified by the user.

9. The system of claim 1, wherein the user profile data structure further comprises:
a sharing preferences field to retain one or more sharing indications to designate a portion of the user profile that may be shared.

10. The system of claim 1, wherein the user profiling application comprises:
a parsing data module to parses the browsing data to create the one or more identification data structures; and
an interest generation module to identify the system generated user interest from the one or more identified terms.

11. An apparatus comprising:
a plurality of behavior files, each behavior file defining how browsing data is parsed for a particular site to identify at least one of a heading or a topic within the browsing data, and
a system analysis file to define how the parsed browsing data is to be analyzed to generate the system generated user interest selected from among the at least one of a heading or a topic for use by a plurality of sites.

12. The apparatus of claim 11, further comprising:
a number of site analysis files, each of the site analysis files defining how the parsed browsing data is to be analyzed for an associated site to generate the system generated user interest for use with the associated site.

13. A method comprising:
accessing a behavior file and an analysis file;
parsing browsing data received from a first site using the behavior file, the behavior file defining how the browsing data is parsed for the first site to identify at least one of a heading or a topic within the browsing data;
analyzing the parsed browsing data with the analysis file to identify one or more system generated user interests, the analysis file defining how the parsed browsing data is to be analyzed to generate the one or more system generated user interests; and
updating a user profile with the one or more system generated user interests.

14. The method of claim 13, further comprising:
providing a shared portion of the user profile to at least one of the first site or a second site.

15. The method of claim 14, further comprising:
browsing at least one of the first site or the second site to which the shared portion of the user profile was provided.

16. The method of claim 15, wherein parsing browsing data received from a first site using a behavior file comprises:
identifying a heading or a topic in the browsing data using the behavior file; and
creating an identification data structure for the identified heading or the identified topic.

17. The method of claim 15, wherein parsing browsing data received from a first site using a behavior file comprises:
identifying a heading or a topic in the browsing data using the behavior file; and
updating an identification data structure for the identified heading or the identified topic.

18. The method of claim 17, wherein analyzing the parsed browsing data with an analysis file comprises:
accessing a system threshold from the analysis file;
accessing the identification data structure for the identified heading or the identified topic; and
recording the system generated user interest of the identified heading or the identified topic in the user profile for the analysis file when the system threshold is met.

19. The method of claim 18, further comprising:
selecting at least one of a time threshold, a page threshold, a searches threshold, a site threshold, or a combined threshold as the system threshold.

20. The method of claim 17, further comprising:
selecting a category of a plurality of items as the heading; and
selecting an item from the plurality of items as the topic.

21. The method of claim 17, wherein analyzing the parsed browsing data with an analysis file comprises:
accessing an interest evaluation from the analysis file;
accessing the identification data structure for the identified heading or the identified topic;
evaluating the interest evaluation on the identification data structure to determine whether a system generated user interest should appear in the user profile and a level at which the system generated user interest should appear; and
recording a system generated user interest of the identified heading or the identified topic and an interest level in the user profile for the analysis file based on evaluation of the interest evaluation.

22. The method of claim 21, further comprising:
selecting at least one of a casual interest level interest, an enthusiast interest level, or a high interest level as the interest level.

23. The method of claim 13, wherein accessing a behavior file and an analysis file comprises:
download at least one of a behavior file, a site analysis file, or a system analysis file from a central server.

24. The method of claim 23, further comprising selecting a system analysis file as the analysis file.

25. The method of claim 13, wherein accessing a behavior file and an analysis file comprises:
selecting a site analysis file as the analysis file.
downloading at least one of a behavior file or the site analysis file from the first site.

26. A method comprising:
receiving a system generated user interest of a user profile, the system generated user interest generated client-side in response to analysis and parsing of browsing data received from a plurality of sites; and
providing customized browsing data to a user associated with the user profile using the system generated user interest.

27. The method of claim 26, wherein providing browsing data customized with the system generated user interest to the user comprises:
providing user customized browsing data to the user using the system generated user interest and a site tracking profile of the user, the site tracking profile generated server-side.

28. A machine-readable medium comprising instructions, which when executed by a machine, cause the machine to:
parse browsing data received from a first site using a behavior file, the behavior file defining how the browsing data is parsed for the first site to identify at least one of a heading or a topic within the browsing data;
analyze the parsed browsing data with an analysis file to identify one or more system generated user interests, the analysis file defining how the parsed browsing data is to be analyzed to generate the one or more system generated user interests; and
update a user profile with the one or more system generated user interests.

29. The machine-readable medium of claim 28, further comprising instructions, which when executed by a machine, cause the machine to:
provide a shared portion of the user profile to at least one of the first site or a second site, the shared portion of the user profile including the one or more system generated user interests.

30. The machine-readable medium of claim 29, further comprising instructions, which when executed by a machine, cause the machine to:
authenticate the first site or the second site to which the shared portion of the user profile will be provided.

31. The machine-readable medium of claim 29, further comprising instructions, which when executed by a machine, cause the machine to:
browse at least one of the first site or the second site to which the shared portion of the user profile was provided.
